(19) United States
(12) Patent Application Publication
(10) Pub. No.: US 2023/0282427 A1
(43) Pub. Date: Sep. 7, 2023

(54) TYPING ASSISTANCE MEMBER AND KEYBOARD

(71) Applicants: Takayuki SUGA, Saitama (JP); Ayano SUGA, Saitama (JP)

(72) Inventors: Takayuki SUGA, Saitama (JP); Ayano SUGA, Saitama (JP)

(21) Appl. No.: 17/767,925

(22) PCT Filed: Jun. 8, 2020
(86) PCT No.: PCT/JP2020/022553

§ 371 Date: Apr. 11, 2022

(30) Foreign Application Priority Data
Oct. 15, 2019 (JP) 2019-188332

(51) Int. Cl. H01H 13/14; G06F 3/02; H01H 13/70

(52) U.S. Cl. CPC H01H 13/14; G06F 3/0202; H01H 13/70

(57) ABSTRACT

Problem: Provided are a typing assistance member that enables keys located away from character keys, such as a backspace key, an enter key, and a delete key, which are relatively frequently used, to be easily pressed, and can suppress erroneous key input, and a keyboard provided with the typing assistance member.

Solution: A typing assistance member is fixed on a predetermined key of a keyboard used in a personal computer. The typing assistance member is a columnar pressing column disposed such that the key can be pressed by fixing one end to a pressing surface of the key, and a height of the pressing column is larger than a stroke depth of the key.

### TECHNICAL FIELD

The present invention relates to a typing assistance member that assists in typing using a keyboard of a personal computer and a keyboard.

### BACKGROUND ART

Keys of a keyboard used for input in a personal computer are generally arranged in the same way regardless of keyboards. Once the arrangement is memorized, it is possible to perform typing without looking at keys of a keyboard. An operation of performing typing while looking at a screen without looking at a keyboard is generally called blind touch.

When starting typing with blind touch, the little finger of the left hand is placed on the “A” key, the ring finger of the left hand is placed on the “S” key, the middle finger of the left hand is placed on the “D” key, and the index finger of the left hand is placed on the “F” key. The index finger of the right hand is placed on the “J” key, the middle finger of the right hand is placed on the “K” key, the ring finger of the right hand is placed on the “L″ key, and the little finger of the right hand is placed on the ﾞ;″ key. In this way, in a case where typing is performed, by placing the fingers on the most frequently used character keys, the keys can be pressed efficiently and quickly.

As for an arrangement of keys of a keyboard, the symbol keys are arranged on the little finger side of the right hand, and the backspace key, the enter key, the delete keys, and other keys that are relatively frequently used are arranged on the right side. Thus, when typing, the fingers of both hands are placed to the left of the keyboard. Since these keys are located away from the little finger of the right hand, it is difficult for beginners of blind touch to press these keys with blind touch.

Therefore, for example, PTL 1 discloses a keyboard in which, in order to avoid pressing a backspace key due to erroneous input during typing, a thin sensor is provided on a pressing surface of the key, and in a case where the end of the key is pressed, the pressing is recognized to be erroneous input, and the key input is automatically canceled.

### CITATION LIST

### Patent Literature

[PTL 1] Japanese Unexamined Patent Publication No. 4-346114

### SUMMARY OF INVENTION

### Technical Problem

However, since the keyboard disclosed in PTL 1 recognizes erroneous input with the sensor provided on the pressing surface of the key, the sensor is required to be thin enough not to hinder typing. In a case where the sensor is thick, moving the finger to the key to be pressed causes the finger to collide with the sensor, which rather causes erroneous input.

In the invention disclosed in PTL 1, input of a character recognized to be erroneous input is canceled. Therefore, in a case where keys are pressed continuously in blind touch, input of all characters after the canceled character may be erroneous input.

The invention described in PTL 1 is regarded to be able to avoid pressing the backspace key which is difficult to blind touch, and, thus, at first glance, it seems to be suitable for beginners of blind touch. However, since beginners of blind touch have a high frequency of erroneous input, it is considered easier to type by actively using the backspace key.

In addition to this, along with the backspace key, it is thought that the return key and delete key located on the right side of the little finger of the right hand are frequently used when performing blind touch, and thus these keys being easily pressed for beginners of blind touch improves a document creation speed, and such demand is increasing more and more.

As described above, since these keys are frequently used, there is an increasing demand for typing without looking at these keys even when typing while looking at the keys instead of blind touch. Of course, avoiding erroneous input of these special keys must be possible when typing.

An object of the present invention is to provide a typing assistance member that enables keys located away from character keys, such as a backspace key, an enter key, and a delete key, which are relatively frequently used, to be easily pressed, and can suppress erroneous key input, and a keyboard provided with the typing assistance member. Solution to Problem

Erroneous key input that occurs when typing may be caused by the fact that all keys are at the same height and that frequently used special keys and operation keys are located away from the character keys.

In order to enable anyone to press such special keys and operation keys without error, instead of disposing a thin member on the key pressing surface so as not to hinder typing as in the related art, by disposing tall members among these keys, the inventors have focused on the fact that the members are marks for the keys that are difficult to press and the keys that are difficult to press can be easily pressed. Here, in a case where a height of a member fixed to a pressing surface of a key is not large, the member does not function as a mark for a key that is difficult to press, and thus a person looks at the key that is difficult to press and then presses the key in the same manner as in the case where the member is not disposed. When pressing such a thin member, in a case where a pressing position is at the end of the member, an adjacent key may also be pressed when the key is pressed, which may cause erroneous input.

Therefore, in the present invention, by making a height of the member fixed to the pressing surface of the key larger than a stroke dispose of the key, even when the key is pressed, the adjacent key is not accidentally pressed. At the same time, because the height of the member is large, the member is a mark for the key when typing, and the key can be pressed without having to bother to align the line of sight with the key.

The present invention made as described above is as follows. (1) A typing assistance member that is fixed on a predetermined key of a keyboard used in a personal computer, in which the typing assistance member is a columnar pressing column disposed such that the key can be pressed by fixing one end to a pressing surface of the key, and a height of the pressing column is larger than a stroke depth of the key.

(2) The typing assistance member according to the above (1) above, in which the predetermined key is a backspace key, a delete key, or an enter key.

(3) The typing assistance member according to the above (1) or (2), in which the pressing column is fixed with an adhesive.

(4) The typing assistance member according to any one of the above (1) to (3), in which a sectional area of the pressing column is smaller than a sectional area of the pressing surface of the key.

(5) The typing assistance member according to any one of the above (1) to (4), in which the pressing column includes a height adjustment mechanism.

(6) The typing assistance member according to any one of the above (1) to (5), in which a plate-shaped member having a larger area than an area of the pressing surface of the key is provided at an upper end of the pressing column.

(7) The typing assistance member according to any one of the above (1) to (5), in which the keyboard includes at least a character key group and a special key group including the backspace key and the enter key, and has an outer peripheral region in which keys are not arranged on an outer periphery of key groups including the character key group and the special key group, and the pressing column is connected to a support column of which one end is fixed to the outer peripheral region via an arm extending from the other end of the support column to the pressing column.

(8) The typing assistance member according to any one of the above (1) to (5), in which the keyboard is a full keyboard including a character key group, a special key group including the backspace key and the enter key, a function key group, a cursor key group, a hardware key and operation key group, and a ten-key group, has an outer peripheral region in which keys are not arranged on an outer periphery of key groups including the character key group, the special key group including the backspace key and the enter key, the function key group, the cursor key group, the hardware key and operation key group, and the ten-key group, and has a gap region in which the keys are not arranged between the cursor key group and the hardware key and operation key group, and the pressing column is connected to a support column of which one end is fixed to the outer peripheral region or the gap region via an arm extending from the other end of the support column to the pressing column.

(9) The typing member according to the above (7) or (8), in which the arm is provided with a length adjustment mechanism.

(10) The typing assistance member according to any one of the above (7) to (9), in which a plate-shaped member having a larger area than an area of the pressing surface of the key is provided on the arm.

(11) The typing assistance member according to any one of the above (7) to (10), in which the support column is fixed with an adhesive.

(12) The typing assistance member according to any one of the above (7) to (11), in which the support column includes a height adjustment mechanism.

(13) The typing assistance member according to the above (7) or (8), in which the arm has a first arm portion and a second arm portion, the second arm portion has a space portion inside thereof and an opening portion at one end thereof, and the opening portion is configured to lead to the space portion, and a length of the first arm portion is adjustable by inserting the first arm portion into the space portion through the opening portion.

(14) The typing assistance member according to the above (13), in which one end of the pressing column is connected to a first plate-shaped member, the first plate-shaped member further has one side, the one side has a rotatable shaft portion, and the shaft portion is rotatably held by the second arm portion, and one end of the support column is connected to a second plate-shaped member, the second plate-shaped member further has one side, the one side has a rotatable shaft portion, and the shaft portion is rotatably held by the first arm portion.

(15) A keyboard including the typing assistance member according to any one of the above (7) to (14).

### BRIEF DESCRIPTION OF DRAWINGS

FIG. 1 is a perspective view showing a state in which a typing assistance member according to an embodiment of the present invention is fixed to a pressing surface of a key.

FIG. 2 is a diagram showing an example of a keyboard.

FIG. 3 is a perspective view showing an example of a height adjustment mechanism in a typing assistance member according to the embodiment of the present invention.

FIG. 4 is a perspective view showing a typing assistance member according to an embodiment of the present invention, which is provided with a plate-shaped member at the other end.

FIG. 5 is a perspective view showing a state in which a pressing column is connected to a support column via an arm in a typing assistance member according to an embodiment of the present invention.

FIG. 6 is a perspective view showing a state in which a plate-shaped member is provided on an arm in a typing assistance member according to an embodiment of the present invention.

FIG. 7 is a perspective view showing a state in which a typing assistance member according to an embodiment of the present invention is fixed to a keyboard, and is a perspective view showing a state in which a pressing column fixed such that a backspace key can be pressed is connected to a support column which is fixed in an outer peripheral region of the keyboard via an arm.

FIG. 8 is a perspective view showing a state in which a pressing column is connected to a support column via an arm in a typing assistance member of Example 2 according to the embodiment of the present invention.

FIG. 9A is a plan view showing a state in which a first arm portion and a second arm portion are separated. FIG. 9B is a plan view showing a state in which the first arm portion and the second arm portion are connected.

FIG. 10A is a side view showing a state in which a pressing column and a support column stand upright in a typing assistance member of Example 2 according to the embodiment of the present invention. FIG. 10B is a side view showing a state in which the pressing column and the support column have fallen.

FIG. 11A is a perspective view showing the first arm portion. FIG. 1B is a perspective view showing the second arm portion.

FIG. 12 is a perspective view showing a state in which the typing assistance member of Example 2 according to the embodiment of the present invention is fixed to the keyboard, and is a perspective view showing a state in which the pressing column fixed such that the backspace key can be pressed is connected to the support column which is fixed in an outer peripheral region of the keyboard via the arm.

### DESCRIPTION OF EMBODIMENTS

Embodiments of the present invention will be described in detail with reference to the drawings. The typing assistance member and the keyboard according to the present invention are not limited to the contents described in the embodiments.

### 1. Typing Assistance Member

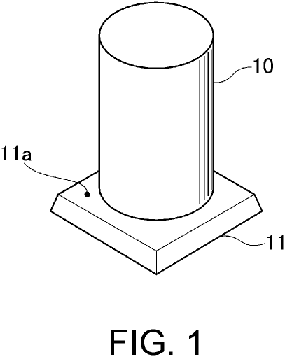

FIG. 1 is a perspective view showing a state in which a typing assistance member 10 according to an embodiment of the present invention is fixed to a pressing surface 11a of a key 11. As shown in FIG. 1, the typing assistance member 10 according to the embodiment of the present invention has a columnar shape, and its height is larger than that of the stroke of the key 11. Consequently, the typing assistance member 10 enters a visual field and serves as a mark for the key 11, and thus a user can easily recognize position of the typing assistance member 10 without directing a line of sight to the key. At the same time, since a pressing finger does not touch an adjacent key even after the pressing is completed, erroneous input can be prevented.

If the height of the typing assistance member 10 is too large, the finger is required to be raised high, which hinders blind touch of continuously pressing various keys. Therefore, for example, the height may be 2 to 3 cm. The typing assistance member 10 is not particularly limited in a sectional shape such as a cylinder or a prism. Here, in the present invention, the typing assistance member 10 presses the key 11, and may thus be hereinafter referred to as a “pressing column” as appropriate.

As shown in FIG. 1, it is preferable that a sectional area of the pressing column that is the typing assistance member 10 is smaller than an area of the pressing surface 11a of the key 11. Consequently, an adjacent key is prevented from being simultaneously pressed due to pressing of the typing assistance member 10. One end of the typing assistance member 10 may be fixed to the pressing surface 11a of the key 11 via an adhesive (not shown). In a case of an adhesive, the typing assistance member 10 can be easily attached and detached, and a fixation target key can be easily changed according to the frequency of use.

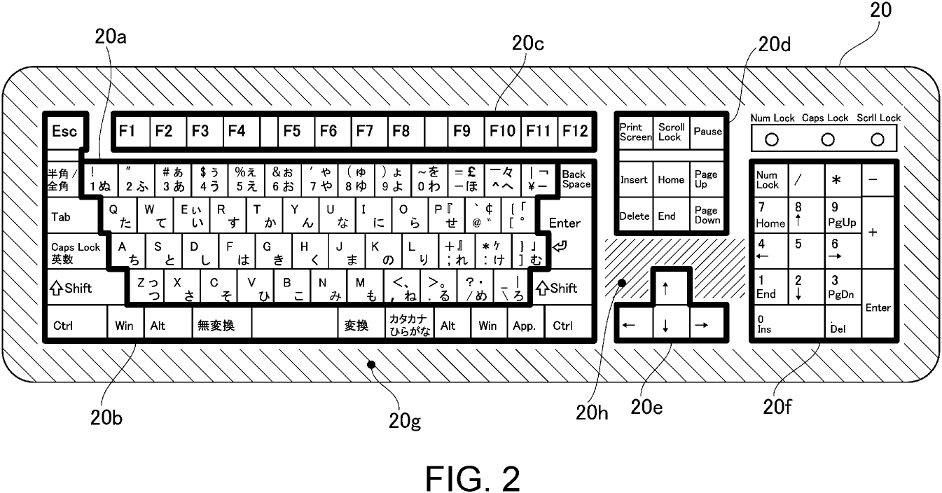

FIG. 2 is a diagram showing an example of a keyboard 20. As shown in FIG. 2, the general keyboard 20 includes a character key group 20a for inputting characters and symbols, a special key group 20b including a backspace key and an enter key, a function key group 20c, and a hardware key and operation key group 20d including a delete key, a cursor key group 20e, and a ten-key group 20f. In a case where a space of a keyboard is restricted as in a notebook PC, at least the character key group 20a and the special key group 20b are provided.

Although the types of keys included in these key groups may vary slightly from keyboard to keyboard, the backspace key, the enter key, and the delete key are usually located further to the right side of the symbol keys included in the character key group 20a. These special keys are pressed with the little finger of the right hand but are far from the character keys such that erroneous input tends to occur. Since the delete key is located further to the right side of the enter key and the back space key, a probability of erroneous input is further increased for beginners of blind touch. In addition to this, these keys are used relatively frequently, resulting in slow typing speed due to erroneous input.

Even with the keyboard 20 having such a key arrangement, by installing the typing assistance member according to the present invention on the pressing surfaces of these special keys, the arrangement of these keys can be easily checked, and erroneous input is prevented without directing the line of sight to the special keys.

As shown in FIG. 2, the keyboard for a desktop includes an outer peripheral region 20g in which the keys are not arranged in an outer periphery of these key groups. As shown in FIG. 2, some keyboards include a gap region 20h in which keys are not arranged between the cursor key group 20e and the hardware key and operation key group 20d. These regions 20g and 20h are regions necessary for disposing another form of typing assistance member as will be described later. Details thereof will be described later.

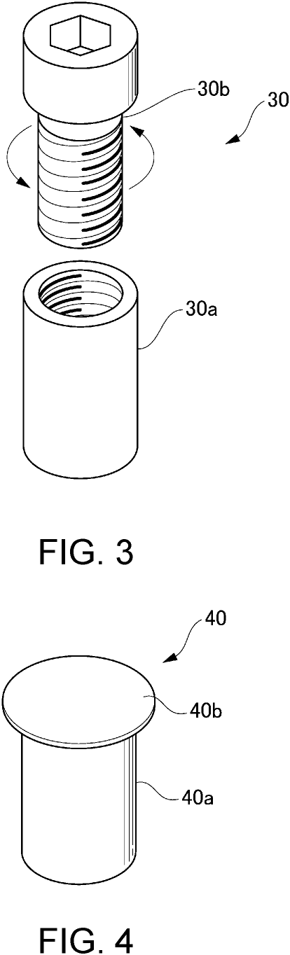

FIG. 3 is a perspective view showing an example of a height adjustment mechanism of the typing assistance member 30 according to the embodiment of the present invention. In the height adjustment mechanism shown in FIG. 3, the typing assistance member 30 is formed of a female screw 30a and a male screw 30b, and both screws are fitted to each other. The height of the pressing column that is the typing assistance member 30 may be adjusted by fixing the lower end of the female screw 30a to the pressing surface of a key (not shown) and then rotating the male screw 30b. In addition, if a spring is inserted in a cylinder and a member smaller than an inner diameter of the cylinder is inserted from the top of the cylinder to the upper end of the spring, the spring elasticity improves the touch feeling and enables smooth typing.

FIG. 4 shows a typing assistance member 40 according to an embodiment of the present invention, which has a plate-shaped member 40b at the other end of a pressing column 40a. By providing the plate-shaped member 40b, it becomes possible to press a key that is difficult to press more easily. An area of the plate-shaped member 40b is preferably large, and may be about twice the pressing surface of the key. Even if the plate-shaped member 40b is provided, the pressing column 40a has a certain height, and thus does not become an obstacle when pressing the “¥” key or the enter key disposed near the backspace key.

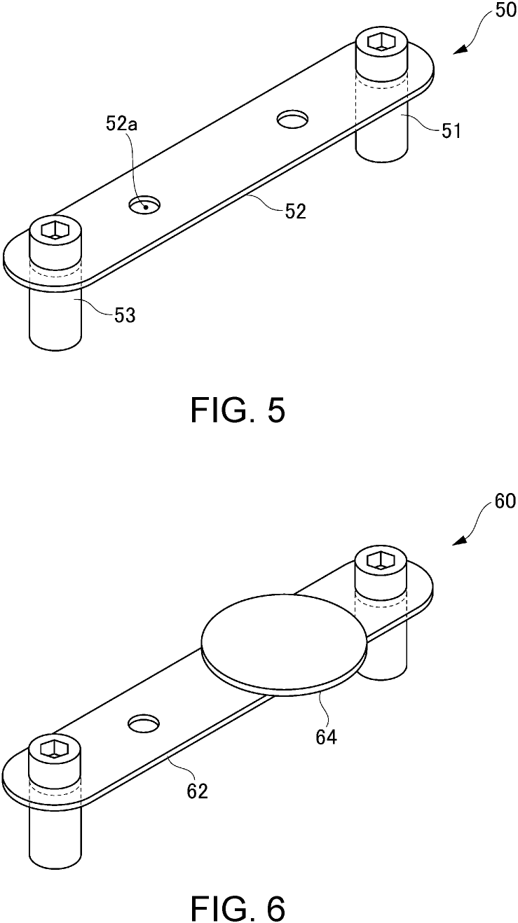

FIG. 5 is a perspective view showing a state in which a pressing column 51 is connected to a support column 53 via an arm 52 in a typing assistance member 50 according to an embodiment of the present invention. Since a pressable range is increased by providing the arm 52, it is possible to press a key that is difficult to press more easily. The arm 52 is provided with, for example, a length adjustment hole 52a as a length adjustment mechanism, and a position of the pressing column 51 can be easily adjusted when a key near the support column 53 is pressed.

A play may be provided in a connection portion between the arm 52 and the pressing column 51 and a connection portion between the arm 52 and the support column 53 such that an operation of pressing a key by pressing the arm 52 is possible. In the same manner as the pressing column 51, the support column 53 may be fixed with a material that can be easily attached and detached, such as an adhesive, and if the adhesive has elasticity, an operation of pressing a key is possible even if there is no play as described above.

A position of the length adjustment hole 52a may be adjusted as appropriate according to a fixation position of the support column 53 or a disposition of a special key. In a case where it is desired to press a key at a position that cannot be reached by the length of the arm 52, the arm 52 may be further connected and used. In addition to this, it is also possible to minimize a movement distance of the finger by connecting and extending the arm 52 to the vicinity of a character key. A width of the arm 52 is preferably smaller than a width of a pressing surface of another key straddling the arm 52, in view of a case where the arm 52 straddles the other key that is not a key to be pressed.

A fixation position of the support column 53 may be moved as appropriate according to a position of a key to which the pressing column 51 is desired to be fixed and a length of the arm 52. The support column 53 may have a height adjustment mechanism as shown in FIG. 3, similarly to the pressing column 51. In the keyboard shown in FIG. 2, since the fixation position of the support column 53 is within a region including the outer peripheral region 20g of the keys, a size of a connection end surface of the support column 53 with the keyboard 20 is not particularly limited as long as the connection end surface is included in the region.

FIG. 6 is a perspective view showing a state in which a plate-shaped member 64 is provided at any position of an arm 62 in a typing assistance member 60 according to an embodiment of the present invention. As shown in FIG. 6, in a case where the plate-shaped member 64 having a large area is provided on the arm 62, a probability of erroneous input is further reduced. An area of the plate-shaped member 64 is preferably larger than an area of a pressing surface of a key, and the area may be about 2 to 3 times the area of the pressing surface of the key. This reduces a probability of accidentally pressing another key. As a mode for achieving the same effect, it is preferable that a width of the plate-shaped member 64 is larger than a width of the arm 62.

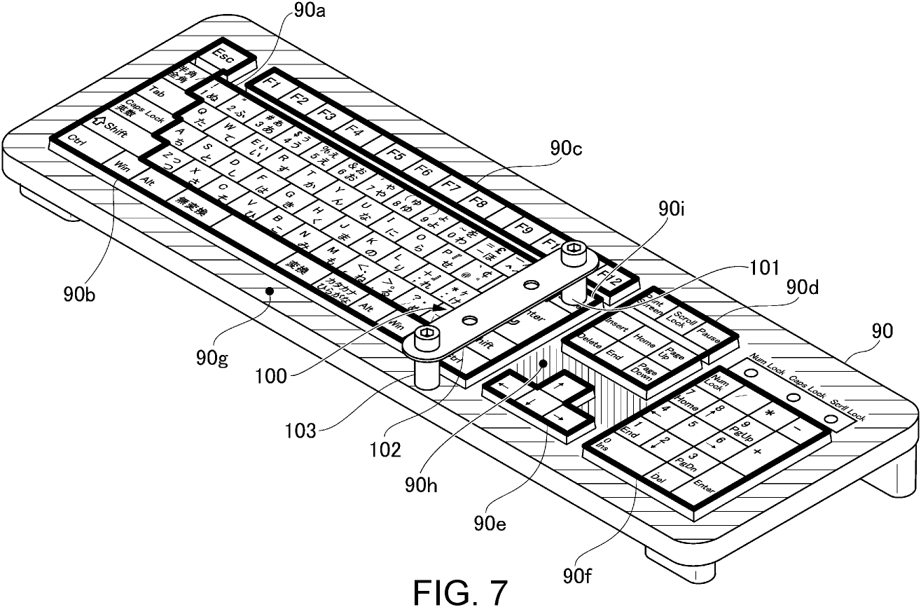

FIG. 7 is a perspective view showing a state in which a typing assistance member 100 according to an embodiment of the present invention is fixed to a keyboard 90, and is a perspective view showing a state in which a pressing column 101 fixed such that a backspace key 90i can be pressed is via an arm 102 is connected to a support column 103 that is fixed in an outer peripheral region 90g of the keyboard 90. In this case, the arm 102 is disposed to straddle the enter key, but a fixation position of the support column 103 may be moved between a cursor key group 90e and a special key group 90b so as not to hinder pressing of the enter key. In a case where there is a gap region 90h in which the keys are not arranged between the cursor key group 90e and a hardware key and operation key group 90d as in the keyboard 90, the support column 103 may be fixed in the gap region 90h.

In FIG. 7, the pressing column 101 is fixed to the backspace key 90i, but may be fixed to the enter key of the special key group 90b, or may be fixed to the delete key of the hardware key and operation key group 90d. As a method of fixing the pressing column 101 and the support column 103, the pressing column 101 and the support column 103 are preferably fixed with an adhesive from the viewpoint of the pressing column 101 securing a stroke for pressing a key and easy attachment/detachment, and more preferably, the adhesive has elasticity.

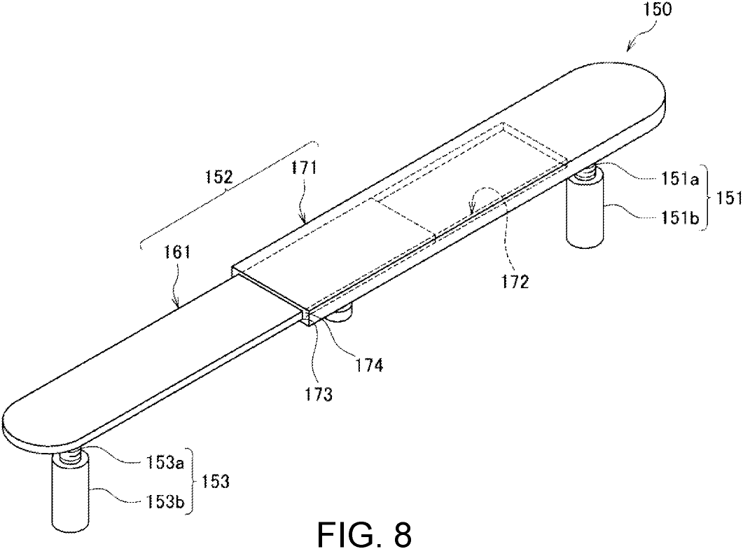

FIG. 8 is a perspective view showing a state in which a pressing column 151 is connected to a support column 153 via an arm 152 in a typing assistance member 150 of Example 2 according to the embodiment of the present invention. The arm 152 has another length adjustment mechanism, and a length of the arm 152 can be adjusted. As described above, by providing the arm 152 of which a length can be adjusted, a pressable range is displaced, and thus it is possible to freely select and press a key that is difficult to press.

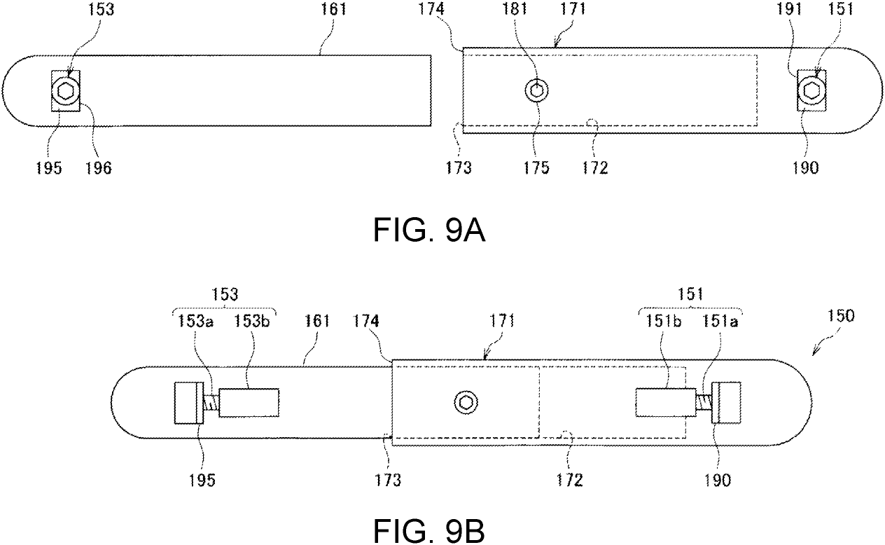

As described above, the arm 52 is provided with, for example, a length adjustment hole 52a as a length adjustment mechanism, but as a second length adjustment mechanism, the arm 152 has a first arm portion 161 and a second arm portion 171. Specifically, the first arm portion 161 has a plate shape. On the other hand, the second arm portion 171 has, for example, a space portion 172 that is an empty space inside like a sword sheath, and has an opening portion 173 that opens at an end portion 174. The opening portion 173 is configured to lead to the space portion 172. The space portion 172 has an internal space into and from which the first arm portion 161 can be inserted and removed. Therefore, the plate-shaped first arm portion 161 can be inserted into the space portion 172 from the opening portion 173 so as to be able to enter and exit the space portion 172, and can thus be used as a second length adjustment mechanism (refer to FIGS. 8 to 11).

The second arm portion 171 has a screw hole 175 that penetrates the space portion 172. By screwing a screw 181 into the screw hole 175, the first arm portion 161 inserted into the space portion 172 and the second arm portion 171 can be fixed at any position by the screw 181. As described above, the arm 152 is configured such that its length can be freely adjusted. Therefore, the above arm 152 can easily adjust a gap between the support column 153 and the pressing column 151. A width of the first arm portion 161 and the second arm portion 171 of the arm 152 is preferably smaller than a width of a pressing surface of another key straddling the arm 152 in view of a case where the arm 152 straddles the other key that is not a key to be pressed (refer to FIGS. 8 to 11).

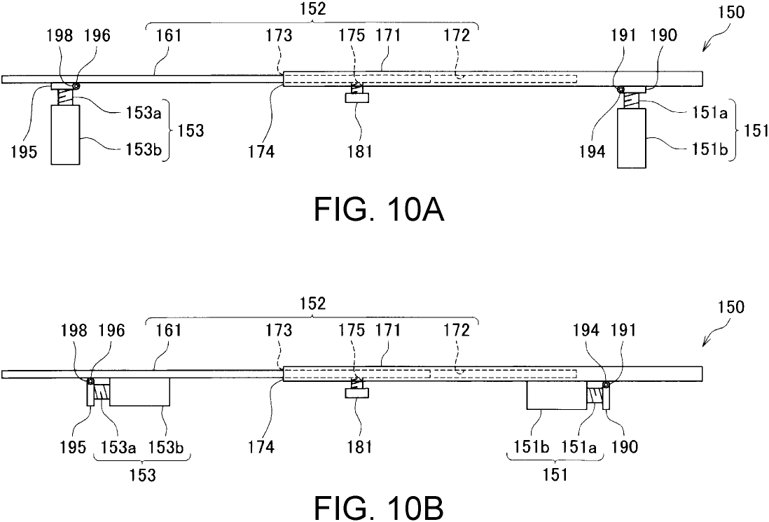

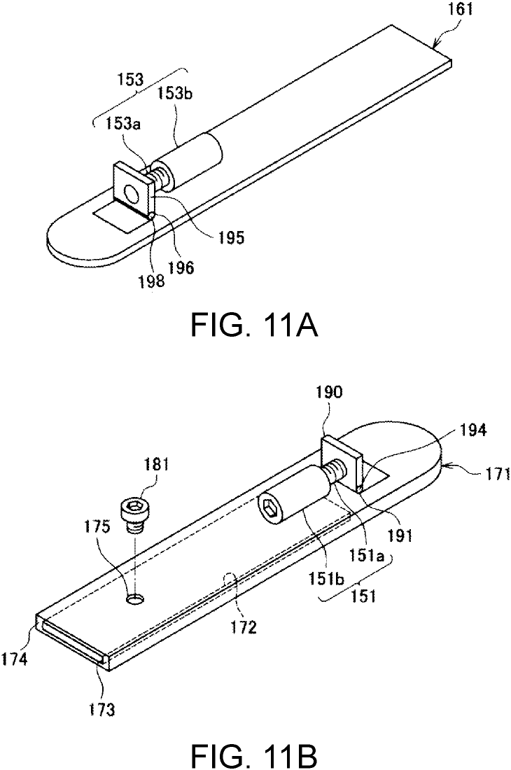

The pressing column 151 and the support column 153 are disposed at both ends of the arm 152, but both are configured to be able to fall. Specifically, one end of the pressing column 151 is connected to a first plate-shaped member 190. The first plate-shaped member 190 has a rectangular shape and a thin plate shape, and a shaft portion 194 is rotatably held on one side 191 thereof. The shaft portion 194 is rotatably held by the second arm portion 171 of the arm 152. Therefore, the shaft portion 194 is rotatably shared by the plate-shaped member 190 and the second arm portion 171 such that the plate-shaped member 190 is rotatable between a horizontal state and a standing state with respect to the second arm portion 171. Consequently, the pressing column 151 can be changed from a standing state to a fallen state. That is, the pressing column 151 is configured to be able to fall with respect to the arm 152 (refer to particularly FIGS. 10A and 10B and FIGS. 11A and B).

The same applies to the support column 153 as follows. One end of the support column 153 is connected to a second plate-shaped member 195. The second plate-shaped member 195 has a rectangular shape and a thin plate shape, and a shaft portion 198 is rotatably held on one side 196 thereof. The shaft portion 198 is rotatably held on the first arm portion 161 of the arm 152. Therefore, the shaft portion 198 is rotatably shared by the plate-shaped member 190 and the first arm portion 161 such that the plate-shaped member 190 is rotatable between a horizontal state and a standing state with respect to the first arm portion 161. Consequently, the support column 153 can be changed from a standing state to a fallen state. That is, the support column 153 is configured to be able to fall with respect to the arm 152 (refer to particularly FIGS. 10A and 10B and FIGS. 11A and B).

From the viewpoint of easy attachment/detachment of the pressing column 151 and the support column 153, it is preferable to fix the pressing column 151 and the column 153 to keys with an adhesive, and it is even more preferable that the adhesive has elasticity. Instead of the adhesive, a male type surface fastener or a female type surface fastener in a surface fastener may be disposed on the pressing column 151 and the support column 153. In that case, by disposing a female type surface fastener or a male type surface fastener on a key, it becomes easier to attach and detach the pressing column 151 and the support column 153 (not shown).

The pressing column 151 and the support column 153 may have a height adjustment mechanism, as shown in FIGS. 11, in the same manner as the support column 53 and the pressing column 51. Specifically, the pressing column 151 has a male thread pressing column portion 151a made of a male thread and a female thread pressing column portion 151b made of a female thread, and a height can be adjusted by screwing the male thread pressing column portion 151a and the female thread pressing column portion 151b together. The support column 153 also has a male thread support column portion 153a made of male threads and a female thread support column portion 153b made of female threads, and a height can be adjusted by screwing the male thread support column portion 153a and the female thread support column portion 153b together.

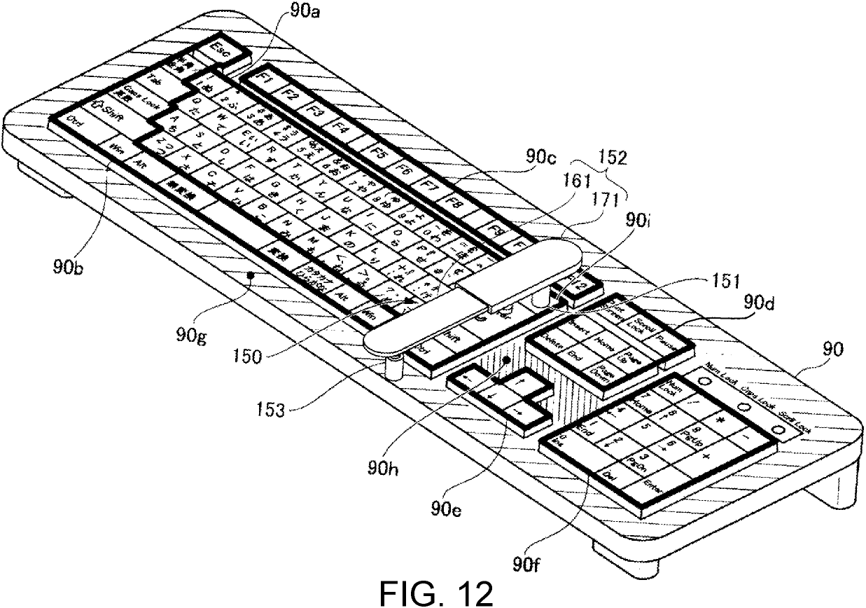

FIG. 12 is a perspective view showing a state in which the typing assistance member 150 of Example 2 is fixed to the keyboard 90, and the pressing column 151 fixed such that the backspace key 90i can be pressed is connected to the support column 153 that is fixed in the outer peripheral region 90g of the keyboard 90 via the arm 152. In this case, the arm 152 is disposed to straddle the enter key, but a fixation position of the support column 153 may be moved between a cursor key group 90e and a special key group 90b so as not to hinder pressing of the enter key. In a case where there is a gap region 90h in which the keys are not arranged between the cursor key group 90e and the hardware key and operation key group 90d as in the keyboard 90, the support column 153 may be fixed in the gap region 90h.

In FIG. 12, the pressing column 151 is fixed to the backspace key 90i, but may be fixed to the special key group 90b or the enter key, or may be fixed to the delete key of the hardware key and operation key group 90d. As a method of fixing the pressing column 151 and the support column 153, the pressing column 151 and the support column 153 are preferably fixed with an adhesive from the viewpoint of the pressing column 151 securing a stroke for pressing a key and easy attachment/detachment, and more preferably, the adhesive has elasticity. As described above, instead of an adhesive, a male type surface fastener or a female type surface fastener in a surface fastener may be disposed on the pressing column 151 and the support column 153. In that case, by disposing a female type surface fastener or a male type surface fastener on a key, it becomes easier to attach and detach the pressing column 151 and the support column 153 (not shown).

In the above description, in the present embodiment, the description has been made of a case where one typing assistance member is fixed in order to press one key, but if a plurality of typing assistance members are disposed not to collide, three and four typing assistance members may be respectively fixed to the enter key, the hardware key, and the delete key. In the present embodiment, a description has been made of a case where the members are provided on the enter key, the hardware key, and the delete key, which are separated from the character keys and are used relatively frequently, but the present invention is not limited thereto. Depending on the content of typing, the typing assistance member of the present embodiment may be provided on a key that is separated from the character keys and is considered to be difficult to touch blindly. Needless to say, the present embodiment can be implemented at least in the combinations described in Solution to Problem.

### 2. Keyboard

A keyboard according to the present embodiment includes the above typing assistance member. The type of keyboard is not particularly limited, and may be any of 104 keyboards, 106 keyboards, and 109 keyboards for Windows, and US keyboards and JIS keyboards for Apple. If there is no outer peripheral region or gap region described above in a keyboard, a typing assistance member including pressing column without a support column and an arm may be used, and if there is the region, either a typing assistance member including a pressing column or a typing assistance member having an arm and a support column may be used.

### REFERENCE SIGNS LIST

10, 30, 40, 50, 60, 100, 150 Typing assistance member
11 Key
11a Pressing surface of key
20, 90 Keyboard
20a, 90a Character key group
20b, 90b (including backspace key and enter key) Special key group
20c, 90c Function key group
20d, 90d (including delete key) Hardware key and operation key group
20e, 90e Cursor key group
20f, 90f Ten-key group
20g, 90g Outer peripheral region
20h, 90h Gap region
30a Female screw
30b Male screw
40a, 51, 101, 151 Pressing column
40b, 64 Plate-shaped member
52, 62, 102, 152 Arm
52a Length adjustment hole
53, 103, 153 Support column
161 First arm portion
171 Second arm portion
90i Backspace key

1. A typing assistance member that is fixed on a predetermined key of a keyboard used in a personal computer, wherein
the typing assistance member is a columnar pressing column disposed such that the key can be pressed by fixing one end of the typing assistance member to a pressing surface of the key, and a height of the pressing column is larger than a stroke depth of the key.

2. The typing assistance member according to claim 1, wherein the predetermined key is a backspace key, a delete key, or an enter key.

3. The typing assistance member according to claim 1, wherein the pressing column is fixed with an adhesive.

4. The typing assistance member according to claim 1, wherein a sectional area of the pressing column is smaller than a sectional area of the pressing surface of the key.

5. The typing assistance member according to claim 1, wherein the pressing column includes a height adjustment mechanism.

6. The typing assistance member according to claim 1, wherein a plate-shaped member having a larger area than an area of the pressing surface of the key is provided at an upper end of the pressing column.

7. The typing assistance member according to claim 1, wherein
the keyboard includes at least a character key group and a special key group including the backspace key and the enter key, and has an outer peripheral region in which keys are not arranged on an outer periphery of key groups including the character key group and the special key group, and
the pressing column is connected to a support column of which one end is fixed to the outer peripheral region via an arm extending from the other end of the support column to the pressing column.

8. The typing assistance member according to claim 1, wherein
the keyboard is a full keyboard including a character key group, a special key group including the backspace key and the enter key, a function key group, a cursor key group, a hardware key and operation key group, and a ten-key group, has an outer peripheral region in which keys are not arranged on an outer periphery of key groups including the character key group, the special key group including the backspace key and the enter key, the function key group, the cursor key group, the hardware key and operation key group, and the ten-key group, and has a gap region in which keys are not arranged between the cursor key group and the hardware key and operation key group, and
the pressing column is connected to a support column of which one end is fixed to the outer peripheral region or the gap region via an arm extending from the other end of the support column to the pressing column.

9. The typing assistance member according to claim 7, wherein the arm includes a length adjustment mechanism.

10. The typing assistance member according to claim 7, wherein a plate-shaped member having a larger area than an area of the pressing surface of the key is provided on the arm.

11. The typing assistance member according to claim 7, wherein the support column is fixed with an adhesive.

12. The typing assistance member according to claim 7, wherein the support column includes a height adjustment mechanism.

13. The typing assistance member according to claim 7, wherein
the arm has a first arm portion and a second arm portion,
the second arm portion has a space portion inside thereof and an opening portion at one end thereof, and the opening portion is configured to lead to the space portion, and
a length of the first arm portion is adjustable by inserting the first arm portion into the space portion through the opening portion.

14. The typing assistance member according to claim 13, wherein
one end of the pressing column is connected to a first plate-shaped member, the first plate-shaped member further has one side, the one side has a rotatable shaft portion, and the shaft portion is rotatably held by the second arm portion, and
one end of the support column is connected to a second plate-shaped member, the second plate-shaped member further has one side, the one side has a rotatable shaft portion, and the shaft portion is rotatably held by the first arm portion.

15. A keyboard comprising the typing assistance member according to claim 1.
